(19) United States
(12) Patent Application Publication
(10) Pub. No.: US 2012/0113762 A1
(43) Pub. Date: May 10, 2012

(54) ELECTRONIC TIMEPIECE APPARATUS WITH RANDOM NUMBER AND PHRASE GENERATING FUNCTIONALITY

(75) Inventor: Cathy S. Frost, Los Angeles, CA (US)

(73) Assignee: Frost Productions LLC, Los Angeles, CA (US)

(21) Appl. No.: 13/280,076

(22) Filed: Oct. 24, 2011

Related U.S. Application Data
(60) Provisional application No. 61/406,122, filed on Oct. 23, 2010.

(51) Int. Cl. G04B 47/00

(52) U.S. Cl. 368/10

(57) ABSTRACT

The disclosed timepiece provides random numbers for use in selecting the numbers for a lottery type game wherein the lottery type game requires a player to select numbers prior to a drawing of numbers. The disclosed timepiece also displays a new fortune each day to the user of the watch, with the new fortune being displayed either visually or audibly to the user.

### PRIORITY STATEMENT

This application claims the benefit of U.S. Provisional Application 61/406,122, filed Oct. 23, 2010.

### FIELD OF INVENTION

The present disclosure relates generally to an apparatus that has the ability to generate random numbers for use in a lottery type game and/or randomly generate phrases, and in particular, the present disclosure relates to a timepiece that generates random numbers for use in a lottery type game wherein the lottery type game requires the player to select a quantity of numbers having a specified range, to be used in the particular lottery type game, and/or phrases, such as fortunes, to be displayed audibly or visually to the user.

### BACKGROUND OF THE INVENTION

Timepieces have been worn or carried for generations, with the first pocket watches being used in the 17^{th} century and the wrist watch becoming popular in the 1920s. The watch has become ubiquitous over time, and in recent decades has converted from merely an analog time piece to use digital technology to display the current time and to provide additional functionality such as that of a stop watch or timer. More recently, the functions of the timepiece have expanded to include receiving and transmitting certain external data, such as heart rate and temperature of the user or the ambient temperature of the surroundings. To date, the wearer of a timepiece, such as a wrist watch can even attach an iPod or other memory devices to the wrist and listen to music or receive input during certain exercise routines, such as walking, jogging or riding a bicycle.

Games of chance have been around for thousands of years. In a game of chance, such as picking numbers from a list of numbers that may be drawn, there is usually no skill required by the player. The odds of predicting the correct numbers varies greatly based on the quantity of the numbers selected and the range of those numbers. Although the actual numbers to be drawn cannot be determined ahead of the selection process, the odds of a particular number being drawn can be determined ahead of time.

In recent years, lotteries have expanded in scope to include games of chance in which a player chooses multiple numbers in a given range. For example, the player may choose six numbers between the range of 1 and 56. By increasing the amount of numbers to be selected, and the range of numbers, the odds of winning become smaller, so the prize, which can rollover if there is no winner becomes greater. Further, by including a larger number of players (for example, players in multiple states), the potential prize increases greatly so that it is not uncommon for a winner of a multistate lottery to win a prize in the range of tens or hundreds of millions of dollars.

In some lotteries, there is a separate number or bonus number that has more value than the other numbers (and may have a different range of numbers). If that number is selected and drawn or chosen, the player can win a small prize (whereas matching only one of the other numbers does not win a prize).

Individuals can become very superstitious about the numbers they select to play the lottery. Often players select birthdays or anniversaries of family members or of friends. Further, some individuals play the same numbers again and again, while others play different numbers each time. It would seem advantageous, if individuals could obtain random numbers by themselves, for assistance in selecting numbers for playing lottery type games. Further, it would be advantageous if individuals could use their watch and did not need to use an additional device to obtain those numbers. The present disclosure provides that functionality.

### SUMMARY OF THE INVENTION

The present disclosure is discussed herein with reference to a timepiece that generates random numbers for use in a lottery type game wherein the lottery type game requires the player to select numbers prior to a “drawing.” If some or all of the selected numbers are chosen or drawn, the player wins a prize, usually in the form of money, and usually an increasing amount depending on how many of the numbers drawn were previously selected. The timepiece can be a wrist watch, a pocket watch, a clock, a pen with an integrated clock, or any other device that indicates time.

The present disclosure also concerns a timepiece that has the ability to provide a new visual or audible fortune to the wearer of the watch each day. The fortune can be displayed as a scrolling fortune on the face of the watch, or as the entire fortune displayed at once. Further, the timepiece may contain a speaker or transducer that is capable of audibly displaying the fortune to the user of the timepiece.

The present disclosure can incorporate each of the functionality described herein either separately or together in one timepiece.

It is an object of the present disclosure to provide a timepiece that assists the user in selecting numbers for a lottery type game.

It is an object of the present disclosure to provide a timepiece that assists the user in selecting numbers for a lottery type game using a dial feature on the face of the timepiece.

It is an object of the present disclosure to provide a timepiece that assists the user in selecting numbers for a lottery type game using a multiple dial feature on the face of the timepiece.

It is an object of the present disclosure to provide a timepiece that assists the user in selecting numbers for a lottery type game using a microprocessor based random number generator to generate random numbers between various ranges that are preset on the timepiece.

It is an object of the present disclosure to provide a timepiece that assists the user in selecting numbers for a lottery type game using a microprocessor based random number generator to generate a particular quantity of random numbers between user defined ranges.

It is an object of the present disclosure to provide a timepiece that assists the user in selecting numbers for a lottery type game including a bonus number for use in certain lottery type games.

It is another object of the present disclosure to provide a timepiece that displays a fortune to the user at an approximate interval of one fortune a day, such that the user must wait until the next day to receive another fortune.

It is another object of the present disclosure to provide a timepiece that displays a fortune to the user at an approximate interval of one fortune a day, and in which the timepiece contains approximately 365 fortunes and an additional set of fortunes can be loaded into the timepiece at about the time that all of the previous fortunes have been displayed.

The present invention and its attributes and advantages will be further understood and appreciated with reference to the detailed description below of presently contemplated embodiments, taken in conjunction with the accompanying drawings.

### BRIEF DESCRIPTION OF THE DRAWINGS

The invention can be better understood by reading the following detailed description of certain preferred embodiments, reference being made to the accompanying drawings in which:

FIG. 1 illustrates a timepiece in accordance with the present disclosure utilizing a dial feature to generate random numbers;

FIG. 2 illustrates a timepiece in accordance with the present disclosure utilizing multiple dial features to generate random numbers;

FIG. 3 illustrates a timepiece in accordance with the present disclosure utilizing a microprocessor based functionality to generate random numbers;

FIG. 4 illustrates a timepiece in accordance with the present disclosure utilizing a microprocessor based functionality to generate random numbers;

FIG. 5 illustrates a timepiece in accordance with the present disclosure utilizing an audible fortune generating feature to display a daily fortune;

FIG. 6 illustrates a timepiece in accordance with the present disclosure utilizing a visual fortune generating feature to display a daily fortune;

FIG. 7 illustrates a timepiece in accordance with the present disclosure utilizing a visual fortune generating feature to display a daily fortune; and

FIG. 8 shows a flowchart of the random number generating functionality in accordance with the present disclosure.

### DETAILED DESCRIPTION OF EMBODIMENTS OF THE INVENTION

The present disclosure concerns a timepiece that generates random numbers for use in a lottery type game wherein the lottery type game requires the player to select numbers prior to the “drawing” and if some or all of those numbers are drawn, the player will win a prize, usually in the form of money, and usually an increasing amount depending on how many of the numbers drawn were previously selected. As an example, a lottery type game may require a player to select six numbers with the numbers ranging from 0 to 56. The more numbers to be selected and the greater the range for each number, the chance of selecting the correct numbers decreases and, in most instances, that will increase the amount of the prize for selecting the correctly drawn numbers.

The present disclosure also concerns a timepiece that has the ability to provide a new visual or audible fortune to the user of the watch each day.

As mentioned above, there are many types of timepiece that display the correct time and other information. Some of the information, such as the time, is consistent and independent of outside data. Some of the information displayed on a timepiece is dependent on receiving information from the outside world, such as heart rate or distance traveled. As such, some timepieces have receivers and/or transmitters for obtaining external information.

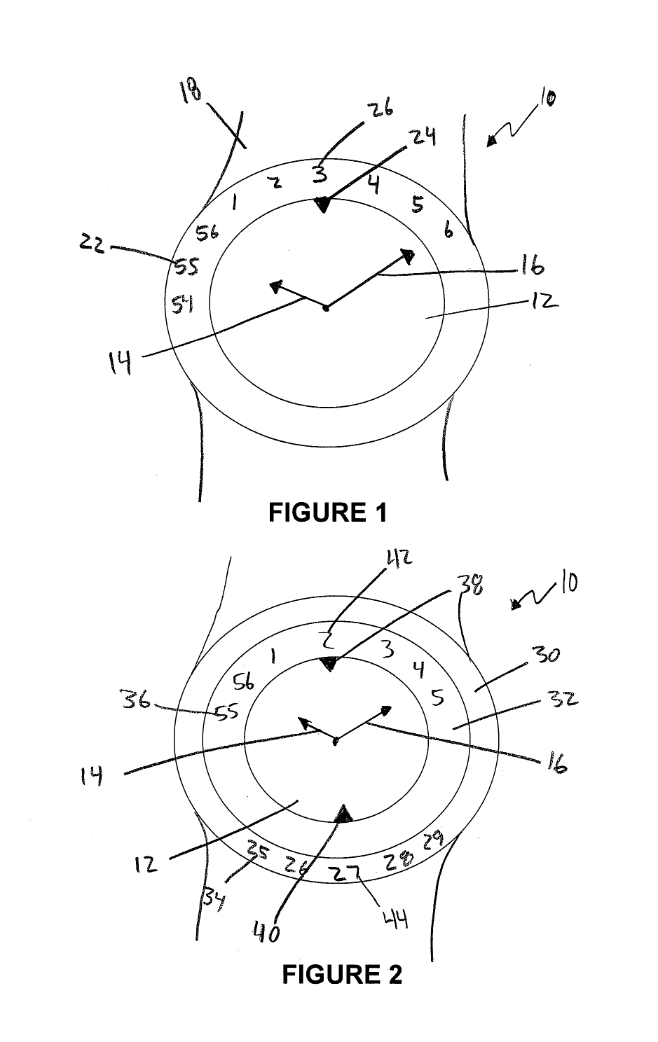

FIG. 1 shows a timepiece 10 in accordance with the present invention. The timepiece has a face 12 and an hour hand 14 and a minute hand 16 and is capable of displaying the correct time to the user of the watch. As described herein, timepieces are capable of providing additional functionality or information to the user, for example, stop watch or timer functionality, or heart rate or distance traveled information.

The present disclosure is not limited to an analog timepiece 10 as shown in FIG. 1, and can display the time in a digital format as understood by one having ordinary skill in the art. The timepiece 10 also has a band 18 which can be used to hold the timepiece to the user's wrist (not shown).

The present disclosure is not to limited in scope to the timepiece 10 shown, and can be applied to a wrist watch, a pocket watch, or even a clock, which is usually placed in a semi-permanent location and not moved around. Further, additional devices, such as a pen, may include a clock or timer and be capable of incorporating the functionality of the present disclosure.

The present disclosure is meant to be a random number generator that can be customized to various lottery type games and is capable of displaying those random numbers to the user to be included as selections for the lottery type game. The present disclosure allows for different quantity of numbers and a user specified range for each of the numbers. Further, the device allows for the user to enter a bonus number if necessary with the same or a different range of numbers.

In the embodiment shown in FIG. 1, the timepiece has one dial with two rows of numbers 20. The dial 20 along the outside of the timepiece 10 will have one or two circular markings of numbers 22 in a chosen range. The dial 20 will have the ability to spin and stop at a random location. Once the dial 20 has been spun and stops at a random location, a fixed indicator mark on the watch 24 will line up with one of the numbers 22 on the dial 20, indicating the selected number 26 of the numbers 22 on the dial 20. In the example shown in FIG. 1, the selected number 26 is “3”. The dial may be spun a number of times to accumulate random numbers as desired.

In an alternative embodiment of the present disclosure, FIG. 2 shows a timepiece 10 having a face 12, an hour hand 14 and a minute hand 16 as in FIG. 1. Instead of a rotating dial 20, this embodiment has two dials 30, 32, each with a row of numbers 34, 36. Each of the two dials 30, 32 along the outside of the timepiece 10 will have circular markings containing multiple numbers 34, 36 in a chosen range.

Each of the two dials 30, 32 will have the ability to spin independently and therefore stop at a random location on the timepiece 10. Once the two dials stop spinning at a random location, one or more fixed indicator marks 38, 40 on the face 12 of the timepiece 10 will line up with one of the multiple numbers 34, 36 on the dials 30, 32, thereby indicating the chosen number 42 or numbers 42, 44. In the example shown in FIG. 2, the selected number for the first dial 30 is “27”, and the selected number for the second dial 32 is “2”. Either dial 30, 32 may be spun a number of times to accumulate random numbers as desired.

As described above, the timepiece 10 can be digital instead of analog. Digital timepieces incorporate a microprocessor to keep track of the time and for various functions such as a stop watch and timer. Most digital timepiece display numbers for the time, however, a timepiece can display other information on the face of the watch, and also can contain an hour hand and a minute hand as an analog timepiece.

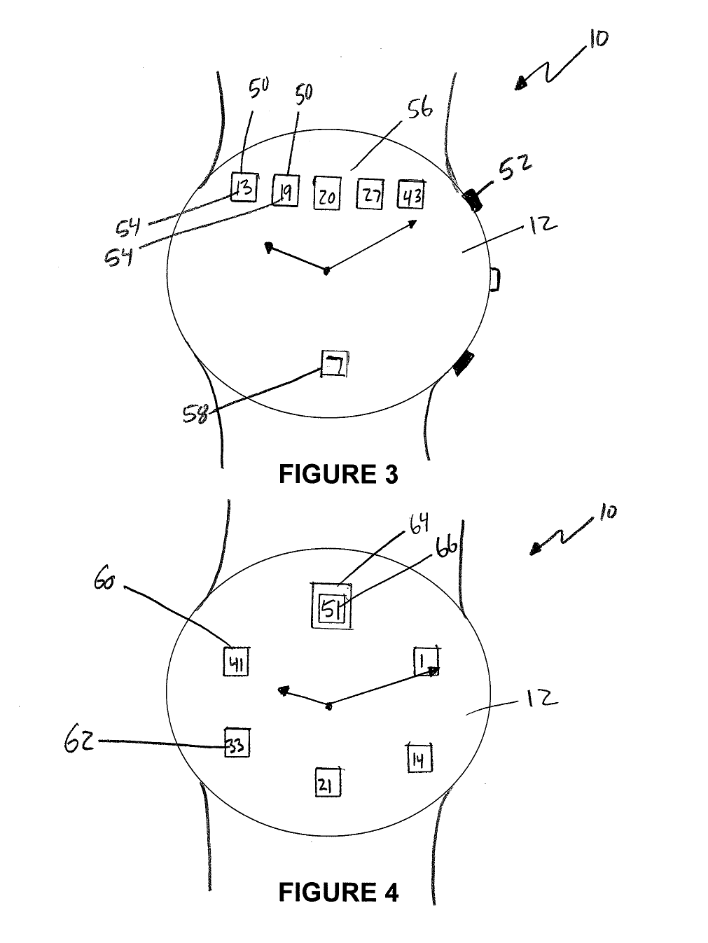

In accordance with another embodiment of the present disclosure, as shown in FIG. 3, various locations 50 on the timepiece 10 will be able to display digital information, including random numbers generated by a microprocessor (not shown). One or more buttons 52 on the timepiece 10, located on the side of the timepiece 10 can be depressed to activate a random number generator (not shown). The random number generator can be in the form of an algorithm stored in memory for example and operated by the microprocessor. The algorithm can be configured to allow the user to enter or input the quantity of numbers to be generated and the range of those numbers. Further, the algorithm may allow for the user to enter information about any bonus numbers and the range of those numbers.

The timepiece 10 will display one or more numbers 54 in a display 56 (in this case, across the top of the face) that the user can use for the selection for a lottery type game. By depressing one or more buttons (depending on the algorithm) the random number generator will activate a virtual “spin” of a fixed number range, and the random numbers generated will be displayed. In the example of FIG. 3, the numbers selected are 13, 19, 20, 27 and 43. The numbers displayed on the face of the timepiece 10 can be grouped as a five area display or can be grouped as one display containing five numbers. Further, the timepiece 10 can be configured for a separate display 58 for a bonus number. In the example shown in FIG. 3, the bonus number 58 is 7.

In an alternative embodiment shown in FIG. 4, a circle pattern 60 of six displayed numbers 62, in this example the numbers 62 are 1, 14, 21, 33, 41 and 51. One of the numbers 62 may have a unique marking 64 on the face 12 of the timepiece 10 to indicate that number as the bonus number 66, in this case the bonus number is 51. The bonus number slot 66 can use a different range of numbers than the other five random numbers that were generated.

The present disclosure is not limited to the examples shown in the figures. The scope of the present disclosure is to allow a user or wearer of a timepiece, such as a wrist watch, the capability of customizing a random number generator integrated into the timepiece, such that the timepiece can generate random numbers, with the quantity and range of those numbers being associated with or representative of a lottery type game of chance.

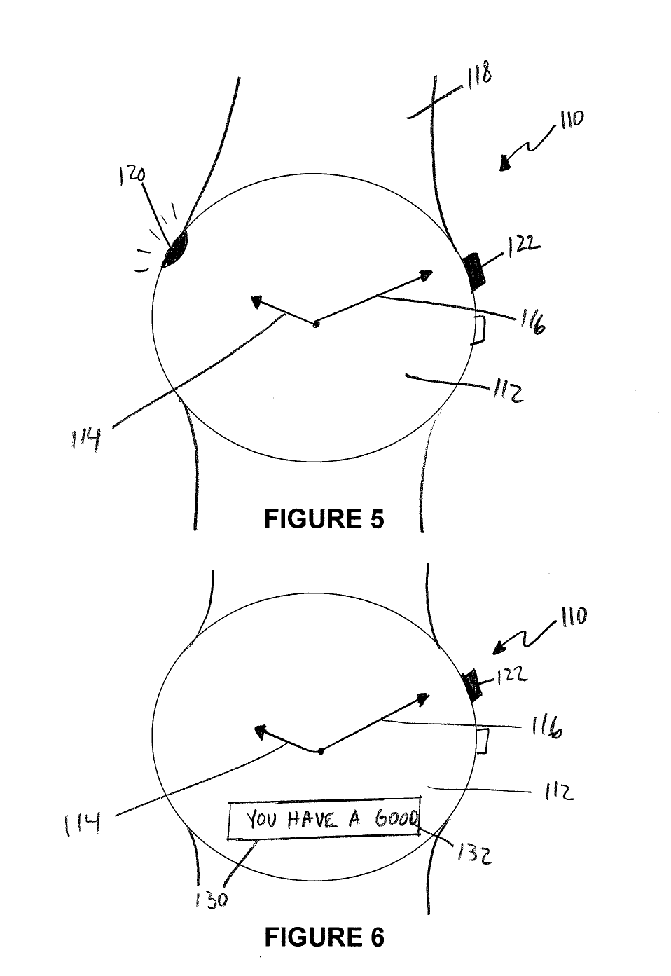

As described above, an alternative embodiment for the present disclosure is a timepiece 110 configured to display visually or audibly a fortune to the user of the timepiece 110. As shown in FIG. 5, the timepiece 110 has a face 112, an hour hand 114 and a minute hand 116, along with a band 118 to allow the timepiece 110 to be worn by the user. The timepiece 110 also contains a speaker or transducer 120 that can play sound that can be heard by the person wearing the timepiece 110.

A button 122 on the timepiece 110 can be depressed by the user to receive an audible fortune through the speaker or transducer 120. Once the button 122 is depressed, the timepiece 110 will obtain a fortune from a database (not shown) and play or “speak” the fortune. In the preferred embodiment, the timepiece 110 will only hold 365 preprogrammed daily fortunes, one of which can be accessed and played each day of the year. The order of the daily fortunes, which can be activated each 24 hours, may or may not be randomly generated. The timepiece 110 will allow for replacements of the 365 daily fortunes after all of the fortunes have been played.

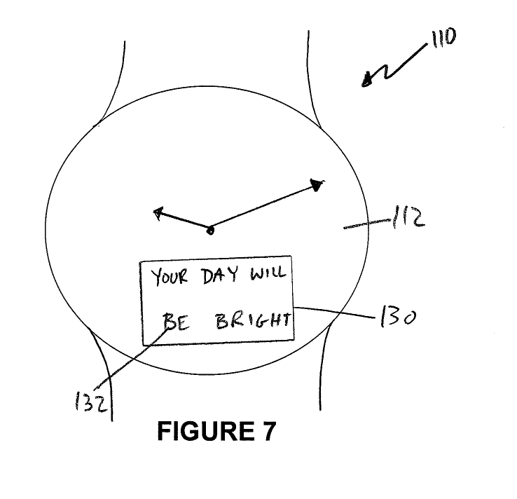

FIGS. 6 and 7 show additional embodiments of the present disclosure in which a fortune is visually displayed digitally on the face 112 of the timepiece 110. In this embodiment, a designated area 130 on the watch face 112 will be used to display a fortune 132 when the button 122 is depressed. The displayed fortune 132 can either be shown scrolling across the display 132 as shown in FIG. 6, or the displayed fortune 132 can be shown as an entire fortune as shown in FIG. 7. Any number of displayed fortunes 132 can be available, however, 365 different fortunes will create a daily fortune for one year, each of the displayed fortunes 132 being available once in a 24 hour period. The order of these daily fortunes 132 may or may not be randomly generated. Replacements for the 365 daily fortunes can be loaded into the timepiece 110 by many different means.

In order to replace the fortunes to be displayed visually or audibly in the timepiece 110, the timepiece 110 can be connected to a personal computer through an attachment such as a cable with a USB connector on one end and a micro USB connector on the other end. The timepiece 110 may have a slot for the micro USB connector to attach thereby allowing the download of additional fortunes when the fortunes in the timepiece 110 have all been displayed. Further, the timepiece 110 may have a wireless receiver and/or transmitter for receiving additional fortunes after the user pays a fee or uses a download application. Further, the present disclosure is not limited to 365 fortunes and may have more or less and still be within the scope of the present disclosure.

In an alternative embodiment, the timepiece may receive (through an internal receiver or when connected to a personal computer or the like), a new fortune every day, with or without the need to store any fortunes in the timepiece 110. The fortune transmitted to the user may be based on information provided by the user with a new fortune being sent to the timepiece 110 and displayed to the user every day based on this provided information.

The random number functionality and fortune telling functionality described above for a timepiece, may be combined into one device or can be separated out in different devices.

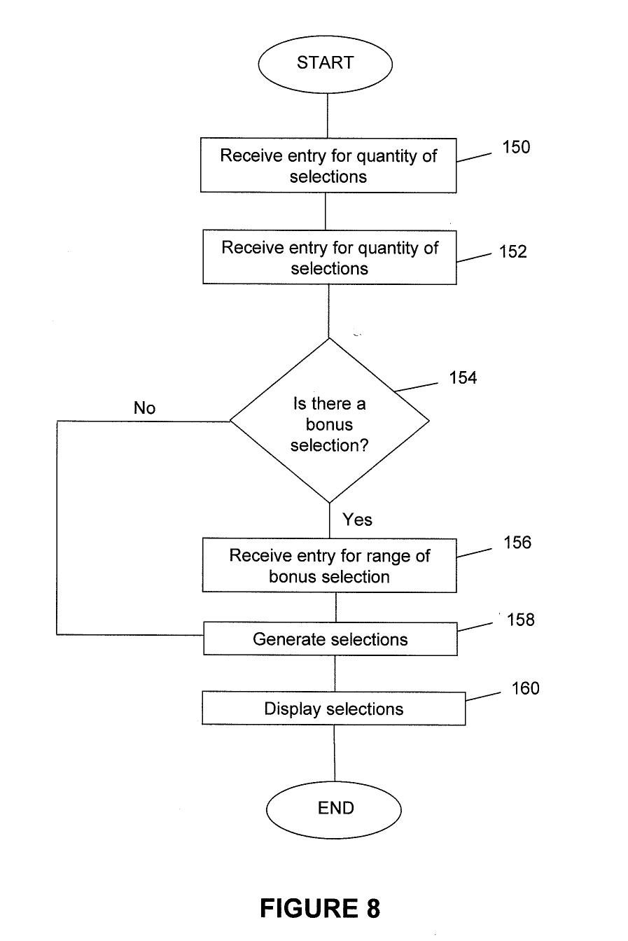

As for the random number functionality described above, FIG. 8 shows a sample flow chart for the timepiece random number generating functionality in which the device allows the user to provide information for a particular type of lottery type game. As described above, the timepiece can be a wrist watch, a clock, a pen (with an integrated clock), or any other device that indicates time. The program is started by pressing a button or placing the timepiece into the number selecting mode. Many devices, such as wrist watches, contain several different modes, such as clock, stop watch, timer, etc., and the number generating functionality could then be included as one of the various modes.

Once the random number generating mode is started, the device is able to receive an entry from the user indicating the quantity of selections that will be required for the particular game 150. For example, in a lottery type game in which six numbers are to be drawn, the user enters the number six. The user can enter the number six by pressing the button 52 six times, or holding down the button 52 while the device cycles through numbers and the user can let go when the device indicates the number six.

Next the device allows the user to enter the range of each of the selections 152. Again the user can depress the button 52 the number of times necessary, or hold the button 52 while the device cycles through the potential range of numbers. Further, the device may allow the user to first select the tens place, then the ones, for example, the user depresses the button 52 five times (for fifty) and then depresses the button 52 three times (for three), thus the range will be from one to 53. Further, the user may be able to enter the beginning range as well, to differentiate games in which the number zero can be drawn. In this example, the user may use two buttons to make the entry.

Once the quantity and range have been entered, the device allows the user to customize the random number generating function to the extent that a bonus number will need to be generated 154. In some lottery type games, the drawing includes, for example, five numbers drawn and a (sixth) bonus number. The bonus number may not have the same range as the other five numbers. In some games, matching the bonus number may result in a prize regardless of whether or not any other numbers are matched.

If the user answers “yes” to the bonus number question, for example depressing the button 52 once, then the device allows the user to enter a range for the bonus selection 156. If the user answers “no” to the bonus number question, for example depressing the button 52 twice, the device does not request a range for the bonus selection.

Once the information has been entered into the device, the device can generate the lottery number selections 158. The random number generator can be a program stored in the microprocessor that is used to keep the time and provide the other functions of the timepiece. Further, the random number generator can be a separate microprocessor that is programmed to provide the random number generating functionality described herein.

Once the quantity of numbers in the proper range have been generated by the device, the numbers are displayed 160 as described herein. The numbers can be displayed one at a time or all at the same time, depending on the configuration of the device.

Although the present disclosure has been described herein as incorporated with a timepiece, the random number generating functionality and the random phrase or fortune displaying capabilities can also be incorporated into a device or apparatus that does not indicate time. Such a device may include a FOB, generally used to lock and unlock the door of an automobile, a pen without a clock function, a keychain pendant, or any other device that is capable of incorporating random number generating functionality or random phrase displaying capabilities as described herein.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

1. A timepiece apparatus for displaying time and random numbers generated for selecting the numbers of a lottery type game of chance, comprising:
a timepiece capable of displaying the time of the day; said timepiece containing a face, said face configured to display the time of the day;
a random number generating device, said random number generating device being located in the timepiece and capable of generating random numbers and displaying said random numbers on or near the face of the timepiece.

2. The timepiece apparatus for displaying time and random numbers of claim 1, wherein said face is configured to display the time of the day in an analog format.

3. The timepiece apparatus for displaying time and random numbers of claim 1, wherein said face is configured to display the time of the day in a digital format.

4. The timepiece apparatus for displaying time and random numbers of claim 1, wherein said random number generating device comprises a first dial located on the circumference of the face of the timepiece, said first dial capable of being spun around said face, said first dial containing a first set of multiple numbers and said face containing a first mark, such that when said first dial is spun around the face of the timepiece, the first dial will stop spinning and one of the multiple numbers will stop in relation to the first mark on the face of the timepiece.

5. The timepiece apparatus for displaying time and random numbers of claim 4, wherein said random number generating device further comprises a second dial located on the circumference of the face of the timepiece and in close association with said first dial, said second dial capable of being spun around said face, said second dial containing second set of multiple numbers and said face containing a second mark, such that when said second dial is spun around the face of the timepiece, the second dial will stop spinning and one of the second set of multiple numbers will stop in relation to the second mark on the face of the timepiece.

6. The timepiece apparatus for displaying time and random numbers of claim 1, wherein said random number generating device is a microprocessor based random number generator, said microprocessor based random number generator being capable of generating at least one random number and displaying said at least one random number on the face of said timepiece.

7. The timepiece apparatus for displaying time and random numbers of claim 6, wherein said random number generating device displays the at least one random number in a straight array across the face of the timepiece.

8. The timepiece apparatus for displaying time and random numbers of claim 6, wherein said random number generating device displays the at least one random number in a circular array across the face of the timepiece.

9. A timepiece apparatus for displaying a fortune to the user of the timepiece, comprising:
a timepiece capable of displaying the time of the day; said timepiece containing a display, said display configured to display a different fortune to the user of the timepiece each day;
said timepiece capable of receiving new fortunes for display to the user of the timepiece.

10. The timepiece apparatus for displaying a fortune of claim 9, wherein said displaying a different fortune is performed visually to the user of the timepiece.

11. The timepiece apparatus for displaying a fortune of claim 9, wherein said displaying a different fortune is performed audibly to the user of the timepiece.

12. The timepiece apparatus for displaying a fortune of claim 9, wherein said receiving new fortunes for display to the user of the timepiece, is done either through a Bluetooth or WiFi connection, or by downloading or uploading said new fortunes into said timepiece.

13. The timepiece apparatus for displaying a fortune of claim 9, wherein said receiving new fortunes for display to the user of the timepiece, is done through a cable connected to a computer.

14. The timepiece apparatus for displaying a fortune of claim 9, wherein said receiving new fortunes for display to the user of the timepiece, is done approximately once every year.

15. The timepiece apparatus for displaying a fortune of claim 9, wherein said receiving new fortunes for display to the user of the timepiece, is done approximately once every day.
